(19) United States
(12) Patent Application Publication
(10) Pub. No.: US 2006/0264575 A1
(43) Pub. Date: Nov. 23, 2006

(54) Peroxide cured butyl compositions having improved hardness and compression set

(76) Inventors: Adam Gronowski, Sarnia (CA); Akhtar Osman, Sarnia (CA); Andrew Carr, Sarnia (CA)

Correspondence Address: LANXESS CORPORATION, 111 RIDC PARK WEST DRIVE, PITTSBURGH, PA, 15275-1112, US

(21) Appl. No.: 11/135,148

(22) Filed: May 23, 2005

(51) Int. Cl. C08F 8/00

(52) U.S. Cl. 525/192

(57) ABSTRACT

The present invention is directed to a peroxide curable rubber compound containing a butyl rubber polymer, an olefin polymer of ethylene, at least one alpha-olefin and optionally at least one diene, and a non-polymeric multi-unsaturated peroxide curable compound. The present invention is also directed to a peroxide curable rubber compound containing a butyl polymer, an EPDM rubber polymer and divinylbenzene or di- or tri-(meth)acrylate. Also the present invention is directed to a process for preparing a peroxide curable rubber compound by mixing a butyl rubber polymer, a polymer of ethylene, at least one α-olefin and optionally, at least one diene and non-polymeric multi-unsaturated peroxide curable cure modifier in the presence of a peroxide curing agent.

### FIELD OF THE INVENTION

The present invention is directed to a peroxide curable rubber compound containing a butyl rubber polymer, an olefin polymer of ethylene, at least one alpha-olefin and optionally at least one diene, and a non-polymeric multi-unsaturated peroxide curable compound. The present invention is also directed to a peroxide curable rubber compound containing a butyl polymer, an EPDM rubber polymer and divinylbenzene or di- or tri-(meth)acrylate. Also the present invention is directed to a process for preparing a peroxide curable rubber compound by mixing a butyl rubber polymer, a polymer of ethylene, at least one α-olefin and optionally, at least one diene and non-polymeric multi-unsaturated peroxide curable cure modifier in the presence of a peroxide curing agent.

### BACKGROUND OF THE INVENTION

In many of its applications, iso-olefin copolymers, in particular butyl rubber is used in the form of cured compounds. The vulcanization is possible through the double bonds of a diene present in polymer molecules. Increasing amounts of isoprene in commercial butyl rubber lead to higher cure rate and higher extent of crosslinking (modulus). Several curing agents or systems are well known. Most often, the sulfur and sulfur-accelerator systems are used.

Peroxide curable rubber compounds offer several advantages over conventional, sulfur-curing systems. Typically, these compounds display very fast cure rates and the resulting cured articles tend to possess excellent heat resistance and low compression set. In addition, peroxide-curable formulations are much ‘cleaner’ in that they do not contain sulfur (extractable inorganic impurity). Such rubber articles can therefore be used, for example, in condenser caps, biomedical devices, pharmaceutical devices (stoppers in medicine-containing vials, plungers in syringes) and possibly in seals in fuel cells.

It is well known that butyl rubber and polyisobutylene decompose under the action of organic peroxides. Therefore, to achieve a cure, the presence of cure promoters (co-agents) is needed.

One approach to obtaining a peroxide-curable butyl-based formulation is in the use of conventional butyl rubber in conjunction with a vinyl aromatic compound like divinylbenzene (DVB) and organic peroxide as disclosed in JP-A-107738/1994. According to JP-A-107738/1194, the compositions preferably contain a conventional vulcanizer of butyl rubber, such as sulfur with accelerators, quinone dioxime or a resin. In place of DVB, an electron-withdrawing group-containing polyfunctional monomer (ethylene dimethacrylate, trimethylolpropane triacrylate, N,N′-m-phenylene dimaleimide) can also be used as disclosed in JP-A-172547/1994.

Sudo et al. (U.S. Pat. No. 5,994,465) discloses a method for curing regular butyl, with isoprene contents ranging from 0.5 to 2.5 mol %, by treatment with peroxide and a bismaleimide species. The rubber composition contains optionally an organosilicone compound and the articles thereof are useful for pharmaceutical chemicals or medical treatments. The compositions of Sudo et al. have excellent molten fluidity after cure.

Co-Pending CA Patent Application 2,458,741 describes the preparation of butyl-based, peroxide curable compounds which employ the use of novel grades of high isoprene butyl rubber. According to this application, N,N′-m-phenylenedimaleimide is useful as a cure promoter (co-agent). Cotsakis et al. (U.S. Pat. No. 6,120,869) discloses a pressure sensitive tape for forming water-tight field joints in rubber membranes. This adhesive roofing tape was based on a combination of brominated butyl rubber and EPDM rubber utilizing a peroxide cure system. Both these rubbers can be cured separately with peroxides alone. An important aspect of Cotsakis, et al. is to have a high molecular weight polyisobutylene as a plasticizer. The degradation products from the action of peroxide on PIB contributed to surface tack.

For some specific applications, like elastic closures for electrolytic condensers (capacitors) the presence of halogens in the compound is not desirable. This is because the halogens present in the elastic rubber cap (in contact with an electrolyte) can interact with a copper wire of the condenser causing corrosion and subsequently electrolyte leakage. Therefore the above-mentioned applications would not be suitable for condenser caps.

Walker et al. (U.S. Pat. No. 3,584,080) claimed peroxide-vulcanizable compositions comprising copolymers of an isoolefin (e.g., isobutylene) and an aromatic divinyl compound (like divinylbenzene) together with a minor amount of a rubbery or resinous polymer (such as PE, NR or EP(D)M rubber) present in a mixed compound. The central aspect of this invention was that each rubber introduced into the compound was peroxide-curable on its own. Both isobutylene-divinylbenzene copolymers and isobutylene-isoprene-divinylbenzene terpolymers are peroxide curable.

The present invention differs from that of Walker et al. in that either no divinylbenzene is present in the isobutylene-containing polymer (i.e., conventional butyl rubber) or the amount of isoprene in the polymer exceeds 4 mol.% (high isoprene butyl rubber.) Also, the DVB-containing butyl rubber used in experiments by Walker et al. had a significant degree of crosslinking (50-80 wt. % gel) while in the present invention the content of a crosslinked fraction in the butyl polymer is preferably below 5 wt. % (high IP butyl) or the polymer is soluble (conventional butyl rubber).

Saotome (JP 55-62943 Al) discloses a thermoplastic elastic polymer composition produced by heating and mixing a mixture of butyl-based rubber (IIR or PIB) and an EP(D)M rubber in the presence of organic peroxide, and partially curing the mixture. The resulting polymer composition has excellent molten fluidity and is intended for hot-melt adhesives and sealants when a tackifier is added to it. The amount of peroxide present in the compound is typically in a range of 0.1 to 1.5 parts per 100 parts of polymer. The examples are based on blends composed of 70 parts of EP(D)M rubber and 30 parts of butyl rubber or PIB. Saotome is specific for compositions having excellent molten processability (and hence the degree of crosslinking has to be limited) and it is silent of the cure state characteristics (e.g., from the MDR test) of the compounds. In fact, the central aspect of Saotome is to suppress the generation of gel which hinders the processability in melt.

G. Natta et al. (U.S. Pat. No. 3,179,715) claimed vulcanized elastomeric compounds comprising EP(D)M, divinylbenzene and organic peroxide and having very good mechanical and elastic properties. An important advantage of such elastomers was a high ultimate tensile strength.

### SUMMARY OF THE INVENTION

It was surprisingly discovered in the present invention that the addition of a small amount of a low molecular weight multi-unsaturated compound like divinylbenzene or tri-(meth)acrylate to compositions containing butyl rubber and EPDM resulted in peroxide cured compounds having improved compression set, hardness and other properties. It was surprisingly discovered in the present invention that a co-agent, such as divinylbenzene or tri-(meth)acrylate was able to act as a cure promoter for both butyl rubber and EPDM used on its own.

The present invention is directed to a peroxide curable rubber compound containing a butyl rubber polymer, an olefin polymer of ethylene, at least one alpha-olefin and optionally at least one diene, and a non-polymeric multi-unsaturated peroxide curable compound.

The present invention is also directed to a peroxide curable rubber compound containing a butyl polymer, an EPDM rubber polymer and divinylbenzene or di- or tri-(meth)acrylate.

The present invention is also directed to a process for preparing a peroxide curable rubber compound by mixing a butyl rubber polymer, a polymer of ethylene, at least one α-olefin and optionally, at least one diene and non-polymeric multi-unsaturated peroxide curable cure modifier in the presence of a peroxide curing agent.

### BRIEF DESCRIPTION OF THE DRAWINGS

FIG. 1 illustrates MDR traces of compounds prepared according to the present invention and comparative compounds.

FIG. 2 illustrates MDR traces of compounds prepared according to the present invention and comparative compounds.

### DETAILED DESCRIPTION OF THE INVENTION

The present invention will now be described for purposes of illustration and not limitation. Except in the operating examples, or where otherwise indicated, all numbers expressing quantities, percentages, and so forth in the specification are to be understood as being modified in all instances by the term “about.” Also, all ranges include any combination of the maximum and minimum points disclosed and include any intermediate ranges therein, which may or may not be specifically enumerated herein.

The present invention relates to butyl polymers. The terms “butyl rubber”, “butyl polymer” and “butyl rubber polymer” are used throughout this specification interchangeably. Suitable butyl polymers according to the present invention are derived from a monomer mixture containing a C₄ to C₇ monoolefin monomer and a C₄ to C₁₄ multiolefin monomer.

Suitable butyl polymers according to the present invention are also essentially gel free (<10 wt.% gel). In connection with the present invention the term “gel” is understood to denote a fraction of the polymer insoluble for 60 minutes in cyclohexane boiling under reflux. According to the present invention the gel content is preferably less than 10 wt.%, more preferably less than 5 wt%, most preferably less than 3 wt% and even most preferably less than 1 wt%.

Preferably, the monomer mixture contains from about 80% to about 99% by weight of a C₄ to C₇ monoolefin monomer and from about 1.0% to about 20% by weight of a C₄ to C₁₄ multiolefin monomer. More preferably, the monomer mixture contains from about 85% to about 99% by weight of a C₄ to C₇ monoolefin monomer and from about 1.0% to about 10% by weight of a C₄to C₁₄ multiolefin monomer. Most preferably, the monomer mixture contains from about 95% to about 99% by weight of a C₄ to C₇ monoolefin monomer and from about 1.0% to about 5.0% by weight of a C₄ to C₁₄ multiolefin monomer.

The preferred C₄ to C₇ monoolefin monomer may be selected from isobutylene, 2-methyl-1-butene, 3-methyl-1-butene, 2-methyl-2-butene, 4-methyl-1-pentene and mixtures thereof. The most preferred C₄ to C₇ monoolefin monomer is isobutylene.

The preferred C₄ to C₁₄ multiolefin monomer may be selected from isoprene, butadiene, 2-methylbutadiene, 2,4-dimethylbutadiene, piperyline, 3-methyl-1,3-pentadiene, 2,4-hexadiene, 2-neopentylbutadiene, 2-methyl-1,5-hexadiene, 2,5-dimethyl-2,4-hexadiene, 2-methyl-1,4-pentadiene, 2-methyl-1,6-heptadiene, cyclopentadiene, methylcyclopentadiene, cyclohexadiene, 1-vinyl-cyclohexadiene and mixtures thereof. The most preferred C₄ to C₁₄ multiolefin monomer is isoprene.

Also, according to the present invention, the butyl polymer may contain a high amount of isoprene, in such cases, the monomer mixture according to the present invention may contain a multiolefin content that is at least greater than 4.1 mol %, more preferably greater than 5.0 mol %, even more preferably greater than 6.0 mol %, yet even more preferably greater than 7.0 mol %.

The monomer mixture used to prepare suitable butyl rubber polymers for the present invention may contain crosslinking agents, transfer agents and further monomers, provided that the other monomers are copolymerizable with the other monomers in the monomer mixture. Suitable crosslinking agents, transfer agents and monomers include all known to those skilled in the art.

Butyl rubber polymers useful in the present invention can be prepared by any process known in the art and accordingly the process is not restricted to a special process of polymerizing the monomer mixture. Such processes are well known to those skilled in the art and usually include contacting the monomer mixture described above with a catalyst system. The polymerization can be conducted at a temperature conventional in the production of butyl polymers, for example, in the range of from −100 ° C. to +50° C. The polymer may be produced by polymerization in solution or by a slurry polymerization method. Polymerization can be conducted in suspension (the slurry method), see, for example, Ullmann's Encyclopedia of Industrial Chemistry (Fifth, Completely Revised Edition, Volume A23; Editors Elvers et al., 290-292). On an industrial scale, butyl rubber is produced almost exclusively as isobutenelisoprene copolymer by cationic polymerization at low-temperatures; cf. for example Kirk-Othmer, Encyclopedia of Chemical Technology, 2nd ed., Vol. 7, page 688, Interscience Pubi., New York/London/Sydney, 1965 and Winnacker-Kuchler, Chemische Technologie, 4th Edition, Vol. 6, pages 550-555, Carl Hanser Verlag, Munchen/Wien, 1962. The expression “butyl rubber” can also denote a halogenated butyl rubber.

The present invention relates to peroxide curable compounds containing a butyl polymer and an olefin polymer of ethylene and at least one α-olefin. Suitable olefin polymers contain monomers of ethylene and at least one α-olefin such as propylene. The olefin polymer can also contain other alpha-olefin monomers, such as 1-butene, hexene-1, octene-1,4-methylpentene-1, decene-1, dodecene-1, tridecene-1, tetradecene-1, pentadecene-1, hexadecene-1, heptadecene-1, octadecene-1, nonadecene-1 and mixtures thereof and/or diene monomers to form terpolymers or tetrapolymers.

Preferably the olefin polymer according to the present invention is a polymer of ethylene, propylene and at least one additional conjugated diene monomer, for example, isoprene and 1,3-butadiene, or an unconjugated diene containing 5 to 25 carbon atoms, for example, 1,4-pentadiene, 1,4-hexadiene, 1,5-hexadiene, 2,5-dimethyl-1,5-hexadiene and 1,4-octadiene; cyclic dienes, for example, cyclopentadiene, cyclohexadiene, cyclooctadiene and dicyclopentadiene; alkylidene and alkenyl norbornenes, for example, 5-ethylidene-2-norbornene, 5-butylidene-2-norbornene, 2-methallyl-5-norbornene, 2-isopropenyl-5-norbornene and tricyclodienes. The unconjugated dienes 1,5-hexadiene, ethylidene norbornene and dicyclopentadiene are preferred.

The term “EPDM” or “EPDM rubber polymer” or “EPDM rubber” are used interchangeably through this specification and denotes ethylene/-propylene/diene terpolymers. EPDMs include rubbers in which the ratio by weight of ethylene to propylene units is in the range from 0.5 to 2.0 and which may contain from 1 to 20 C═C double bonds/1,000 carbon atoms. Suitable diene monomers in the EPDM include the preferred monomers listed above 5-hexadiene, ethylidene norbornene and dicyclopentadiene.

The EPDM rubber useful in the present invention has a residual unsaturation in the side chains and can be cured with peroxides, as well as sulfur. Preferably, EPDM rubber in the present invention has high diene content and is preferable over other grades of EPDM or EP rubber. The diene content in the EPDM is preferably 6.5 to 10.5 mol %, based on EPDM.

The compounds of the present invention contain from 55 to 98 parts of butyl polymer per hundred parts rubber, preferably from 70 to 90 parts phr, and from 2 to 45 parts pf olefin polymer phr, preferably from 10 to 30 phr.

The compounds of the present invention also contain at least one cure modifier. Suitable cure modifiers for the present invention include non-polymeric multi-unsaturated peroxide curable compounds such as divinylbenzene or di- or tri-(meth)acrylate.

One type of a useful cure promoter is a divinyl aromatic compound derived from aromatic compounds such as benzene, naphthalene, phenanthrene, anthracene and diphenyl by replacement of nuclear hydrogen atoms by vinyl or alkyl-substituted vinyl groups. The aromatic nucleus can also be substituted by, for example, alkyl groups so that suitable compounds include divinyl toluenes and divinyl xylenes, as well as divinyl naphthalene, divinyl pyridine, diisopropenylbenzene and, the preferred compound, divinyl benzene.

Another type of a useful cure promoter is a polyfunctional monomer containing an electron-attractive group. Examples include trimethylol-propane tri(meth)acrylate, polyethylene glycol di(meth)acrylate, ethylene di(methacrylate), ethylene glycol di(meth)acrylate, polyethylene glycol diacrylate, 1,6-hexanediol diacrylate, tetramethylolmethane tetracrylate and polypropylene glycol di(meth)acrylate. Although metallic co-agents such as zinc di(meth)acrylate are known to improve, for example, compression set in various peroxide cure applications, they are not preferable in the present case due to a possible negative effect on a conductivity of the final cured compound. This is particularly important in applications where a high electrical resistance must be maintained, for example, elastic closures for electrolytic capacitors (condenser caps).

The compounds of the present invention contain from 1 to 15 parts of a cure modifier per hundred parts rubber, preferably from 2 to 10 parts phr.

The compound of the present invention further contains at least one peroxide curing system. The present invention is not limited to a special peroxide curing system. For example, organic peroxides such as dialkylperoxides, ketalperoxides, aralkylperoxides, peroxide ethers, peroxide esters, such as di-tert.-butylperoxide, bis-(tert.-butylperoxy-isopropyl)-benzene, dicumylperoxide, 2,5-dimethyl-2,5-di(tert.-butylperoxy)-hexane, 2,5-dimethyl-2,5-di(tert.-butylperoxy)-hexene-(3), 1,1-bis-(tert.-butylperoxy)-3,3,5-trimethyl-cyclohexane, benzoylperoxide, tert.-butylcumylperoxide and tert.-butylperbenzoate can be used.

Usually the amount of peroxide in the compound is in the range of from 2 to 10 phr (=per hundred rubber), or, for example, from 4 to 8 phr, preferably from 2 to 5 phr. Subsequent curing is usually performed at a temperature in the range of from 100 to 200° C., for example 130 to 180° C. Peroxides might be applied advantageously in a polymer-bound form. Suitable systems are commercially available, such as Polydispersion T(VC) D-40 P from Rhein Chemie Rheinau GmbH, D (polymerbound di-tert.-butylperoxy-isopropylbenzene).

The compound may further contain at least one active or inactive filler.

Suitable fillers include:
highly dispersed silicas, prepared e.g., by the precipitation of silicate solutions or the flame hydrolysis of silicon halides, with specific surface areas of in the range of from 5 to 1000 m2/g, and with primary particle sizes of in the range of from 10 to 400 nm;
natural silicates, such as kaolin and other naturally occurring silica;
glass fibers and glass fiber products (mafting, extrudates) or glass microspheres;
carbon blacks; the carbon blacks to be used here are prepared by the lamp black, furnace black or gas black process and have preferably BET (DIN 66 131) specific surface areas in the range of from 20 to 200 m2/g, e.g. SAF, ISAF, HAF, FEF or GPF carbon blacks.

Examples of suitable mineral fillers include silica, silicates, clay such as bentonite, gypsum, talc, mixtures of these, and the like. These mineral particles have hydroxyl groups on their surface, rendering them hydrophilic and oleophobic. This exacerbates the difficulty of achieving good interaction between the filler particles and the tetrapolymer. For many purposes, the preferred mineral is silica, or, for example, silica made by carbon dioxide precipitation of sodium silicate. Dried amorphous silica particles suitable for use in accordance with the present invention may have a mean agglomerate particle size in the range of from 1 to 100 microns, or, for example, between 10 and 50 microns or, between 10 and 25 microns. It is preferred that less than 10 percent by volume of the agglomerate particles are below 5 microns or over 50 microns in size. A suitable amorphous dried silica moreover usually has a BET surface area, measured in accordance with DIN (Deutsche Industrie Norm) 66131, of in the range of from 50 and 450 square meters per gram and a DBP absorption, as measured in accordance with DIN 53601, of in the range of from 150 and 400 grams per 100 grams of silica, and a drying loss, as measured according to DIN ISO 787/11, of in the range of from 0 to 10 percent by weight. Suitable silica fillers are available under the trade names HiSil® 210, HiSil® 233 and HiSil® 243 from PPG Industries Inc. Also suitable are Vulkasil S and Vulkasil N, from LANXESS Deutschland GmbH.

It might be advantageous to use a combination of carbon black and mineral filler in the present inventive compound. In this combination the ratio of mineral fillers to carbon black is usually in the range of from 0.05 to 20, or, for example, 0.1 to 10. For the rubber composition of the present invention, it is usually advantageous to contain carbon black in an amount of in the range of from 20 to 200 parts by weight, for example 30 to 150 parts by weight, or, for example, 40 to 100 parts by weight.

The rubber compound according to the present invention can contain further auxiliary products for rubbers, such as reaction accelerators, vulcanizing accelerators, vulcanizing acceleration auxiliaries, antioxidants, foaming agents, anti-aging agents, heat stabilizers, light stabilizers, ozone stabilizers, processing aids, plasticizers, tackifiers, blowing agents, dyestuffs, pigments, waxes, extenders, organic acids, inhibitors, and activators such as triethanolamine, polyethylene glycol, hexanetriol, etc., which are known to the rubber industry. The rubber aids are used in conventional amounts, which depend inter alia on the intended use. Conventional amounts are, e.g., from 0.1 to 50 wt. %, based on rubber.

For example, the compound furthermore may contain in the range of 0.1 to 20 phr of an organic fatty acid, such as a unsaturated fatty acid having one, two or more carbon double bonds in the molecule, which more preferably includes 10% by weight or more of a conjugated diene acid having at least one conjugated carbon-carbon double bond in its molecule.

For example, those fatty acids have in the range of from 8 to 22 carbon atoms, or for example, 12 to 18. Examples include stearic acid, palmitic acid and oleic acid.

The ingredients of the final compound can be mixed together in any known manner, such as by mixing a butyl rubber with EP(D)M rubber and a low molecular weight multi-unsaturated compound. Many known methods for mixing polymers can be utilized. For example, an internal mixer like a Brabender or a Banbury can be used as well as a kneader or a mill. The mixing can be performed at an ambient or elevated temperature. If the low molecular weight multi-unsaturated compound is a liquid (for example, divinylbenzene), it can be easily added simultaneously with the filler (carbon black or clay) during a mixing process.

Furthermore, the present invention provides shaped articles containing the inventive peroxide-curable compound, which would then be vulcanized by heating it over the decomposition temperature of the peroxide and/or radiation. Peroxide curable rubber compounds offer several advantages over conventional, sulfur-curing systems. Typically, these compounds display very fast cure rates and the resulting cured articles tend to possess excellent heat resistance and low compression set. In addition, peroxide-curable formulations are much ‘cleaner’ in that they do not contain sulfur (extractable inorganic impurity).

Articles prepared with compounds according to the present invention also have the preferred properties of EPDM like very good resistance to ozone, weathering, heat, oxidation and good chemical resistance and have the impermeability to gasses and moisture of butyl rubber therefore making compounds according to the present invention suitable for applications such as containers for pharmaceuticals, in particular, stopper and seals for glass or plastic vials, tubes, parts of syringes and bags for medical and non-medical applications, condenser caps and seals for fuel cells, parts of electronic equipment, in particular insulating parts, seals and parts of containers containing electrolytes, rings, dampening devices, ordinary seals, and sealants.

### EXAMPLES

Components

The compounds presented in the examples included the following components: Butyl Rubber (LANXESS XL-10000, from LANXESS or LANXESS RB 402, from LANXESS, or LANXESS experimental high isoprene butyl rubber prepared according to Example 2 of CA Patent Application 2,458,741, from LANXESS); EPDM rubber (Buna EP T 3950 from LANXESS); carbon black (IRB #7 from Balentine Enterprises Inc., N 762 from Cabot Canada), divinylbenzene (ca. 63.5%, from DOW), trimethacrylate non-metallic co-agent (Saret 517 from Sartomer) and peroxide curing agent (DI-CUP 40C from Struktol Canada Ltd. and Perikadox 14/40B-PD from AKZO NOBEL).

Mixing Equipment

Mixing of the rubber compounds was accomplished with the use of a miniature internal mixer (Brabender MIM) from C. W. Brabender, consisting of a drive unit (Plasticorder® Type PL-V151) and a data interface module (Examples 1-6). Mixing was also accomplished using a 6×12 inch two-roll laboratory mill (Farrel, capacity 1000 g) (Examples 7-11).

Physical Testing Procedures

Cure characteristics were determined with a Moving Die Rheometer (MDR) test carried out according to ASTM standard D-5289 on a Monsanto MDR 200 (E). The upper disc oscillated though a small arc of 1 degree.

Curing was achieved with the use of an Electric Press equipped with an Allan-Bradley Programmable Controller.

Stress-strain tests were carried out using an Instron Testmaster Automation System, Model 4464 according to ASTM standard D412, Method A.

The change in stress-strain properties of vulcanizates after aging macro-specimens in hot air ovens complied with ASTM D 573.

Tear properties of the compounds were determined according to Die C Tear test as specified in the norm ASTM D 624.

The test procedure for compression set of vulcanized rubber specimens complied with ASTM D 395 (Method B) with the following exceptions:
a) the thickness of the spacers required have been adjusted to obtain closer deflection tolerances of 25±1.5% versus a tolerance of 25±4% for the ASTM procedure (under its specified thickness range and spacer requirements),
b) specimens with a thickness outside of the ASTM range defined (1.20 to 1.30 cm) were tested under the conditions of (a) above,
c) the surfaces of the plates used to compress the specimens were not chrome plated as ASTM D 395 prescribed.

DIN abrasion test was performed according to DIN 53 516.

Air permeability test for vulcanized compounds was based on ASTM D 1324 (1996).

Determination of the weight and volume change in vulcanizates after immersion in ethylene glycol complied with ASTM D 471, except for the length of the tubes; 260 mm tubes were used to accommodate equipment limitations, instead of 300 mm as specified by ASTM.

### Mixing Procedure for Examples 1-6

In Examples 1-6 mixing was achieved with the use of a Brabender internal mixer (capacity ca. 75 g) with a starting temperature of 35° C. and a mixing speed of 50 rpm according to the following sequence:
0.0 min: polymer(s) added
1.5 min: carbon black added (with Saret or DVB, if present)
7.0 min: peroxide added
8.0 min: mix removed

The final compound was refined on a 6″×12″ mill.

### Mixing Procedure for Examples 7-11

In Examples 7-11 mixing was achieved using a 6″×12″ 2-roll mill (Farrel, capacity 1000 g). The roll temperature was at 75° C. (Mokon set at 75° C.).

The mixing was performed according to the following sequence:
0.0 min: polymers added, ¾ cuts
2.0 min: white filler added (with Saret, if present), ¾ cuts
8.0 min; carbon black added, ¾ cuts
12.0 min; peroxide added, ¾ cuts
15.0 min; mix removed

The final compound was refined (6 passes on a 6″×12″ mill).

### Example 1

### Demonstrative

The compound of Example 1 was based on a commercial butyl rubber (100 phr of LANXESS Butyl RB 402, isobutylene content=97.8 mol %, isoprene content=2.2 mol %) mixed in a Brabender mixer. The amount of carbon black (IRB #7) was 50 phr and the content of DI-CUP 40 C. in the formulation was 3 phr.

No evidence of cure could be seen during the MDR test. This demonstrates that commercial butyl rubber can not be cured with peroxides alone.

### Example 2

### Demonstrative

The compound of Example 2 was based on a commercial butyl rubber (100 phr of LANXESS Butyl RB 402, isobutylene content=97.8 mol %, isoprene content=2.2 mol %) mixed in a Brabender mixer. The remaining ingredients in the formulation were: 50 phr of carbon black (IRB #7), 10 phr of Saret 517 and 5 phr of DI-CUP 40° C.

The cured compound gave the following test results: delta torque=11.54 dN·m, Shore A hardness=52 points, ultimate tensile=0.805 MPa and ultimate elongation=903%.

These results demonstrate that non-polymeric multi-unsaturated peroxide curable compound or cure modifier such as Saret 517 acts as a cure promoter during curing of butyl rubber with peroxides; however, the tensile and elongation properties of the resulting compound were not satisfactory.

### Example 3

### Comparative

The compound of Example 3 was based on a commercial crosslinked butyl rubber (100 phr of LANXESS XL-10000) mixed in a Brabender mixer. The remaining ingredients in the formulation were: 50 phr of carbon black (IRB #7) and 2 phr of DI-CUP 40C.

The cured compound gave the following test results: delta torque=11.45 dN·m, Shore A hardness=57 points, ultimate tensile=4.86 MPa and ultimate elongation=126%.

These results demonstrate that XL-1 0000 can be well cured with peroxides.

### Example 4

### Comparative

The compound of Example 4 was based on a blend of commercial butyl rubber (70 parts of LANXESS Butyl RB 402) and commercial EPDM (30 parts of Buna EP T 3950) mixed in a Brabender mixer. The remaining ingredients in the formulation were: 50 phr of carbon black (IRB #7) and 5 phr of DI-CUP 40° C.

The cured compound gave the following test results: delta torque=13.07 dN·m, Shore A hardness=57 points, ultimate tensile=7.70 MPa and ultimate elongation=123%.

These results were similar or better than the results obtained for a compound containing XL-10000.

### Example 5

### Inventive

The compound of Example 5 was based on a blend of commercial butyl rubber (70 parts of LANXESS Butyl RB 402) and commercial EPDM (30 parts of Buna EP T 3950) mixed in a Brabender mixer. The remaining ingredients in the formulation were: 50 phr of carbon black (IRB #7), 10 phr of DVB and 5 phr of DI-CUP 40° C.

The cured compound gave the following test results: delta torque=25.14 dN·m, Shore A hardness=68 points, ultimate tensile=8.56 MPa and ultimate elongation=121%.

This compound (Compound 5) had improved hardness compared to the similar comparative compound described in Example 4 (Compound 4).

### Example 6

### Inventive

The compound of Example 6 was based on a blend of commercial butyl rubber (70 parts of LANXESS Butyl RB 402) and commercial EPDM (30 parts of Buna EP T 3950) mixed in a Brabender mixer. The remaining ingredients in the formulation were: 50 phr of carbon black (IRB #7), 10 phr of Saret 517 and 5 phr of DI-CUP 40° C.

The cured compound gave the following test results: delta torque=24.86 dn·m, Shore A hardness=68 points, ultimate tensile=8.74 MPa and ultimate elongation=138%.

This compound (Compound 6) had improved hardness compared to the similar comparative compound described in Example 4 (Compound 4).

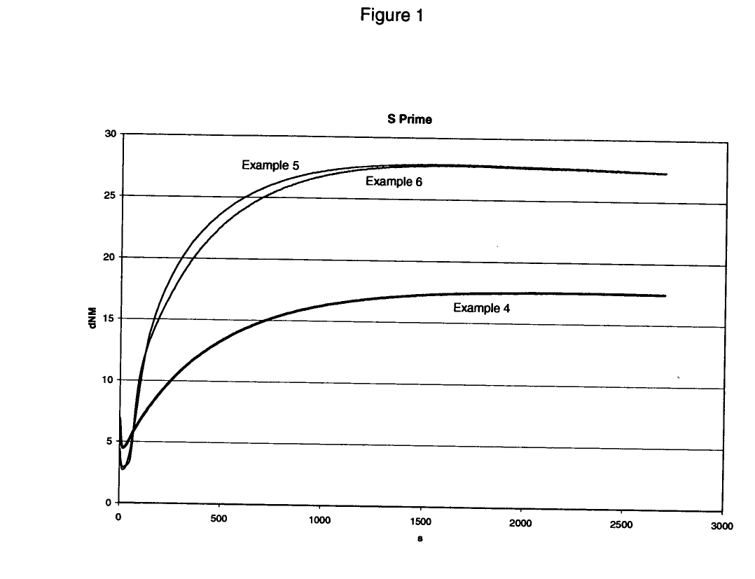

The results for the compositions of Examples 3-6 are summarized in Table 1 and the MDR traces of the compounds 4-6 are given in FIG. 1.

TABLE 1
Properties of Compounds 3-6.

| | System | | | |
|---|---|---|---|---|
| | | | IIR + | IIR + |
| | XL-10000 | IIR + Buna | Buna + | Buna + |
| | Example 3 | Example 4 | DVB | Saret 517 |
| Property | (Comparative) | (Comparative) | Example 5 | Example 6 |
| Hardness, | 57 | 57 | 68 | 68 |
| Shore A | | | | |
| (pts.) | | | | |
| Ultimate | 126 | 123 | 121 | 138 |
| Elongation | | | | |
| (%) | | | | |
| Ultimate | 4.86 | 7.70 | 8.56 | 8.74 |
| Tensile | | | | |
| (MPa) | | | | |
| Δ Torque | 11.45 | 13.07 | 25.14 | 24.86 |
| (dNm) | | | | |

These results demonstrate that the inventive compounds have higher hardness than the two reference compounds while the ultimate elongation is similar or better. Also, delta torque values are significantly improved. A combination of a high hardness and a high elongation is advantageous for condenser cap application.

### Example 7 (Comparative)

The compound of Example 7 was based on a commercial crosslinked butyl rubber (100 phr of LANXESS XL-10000) mixed on a mill. The remaining ingredients in the formulation were: 100 phr of proprietary white filler, 50 phr of carbon black (N 762) and 1.5 phr of Perkadox 1440B-PD.

The test results are given in Table 2.

### Example 8 (Comparative)

The compound of Example 8 was prepared similarly like Compound 7 except that 10 phr of Saret 517 was also present in the formulation.

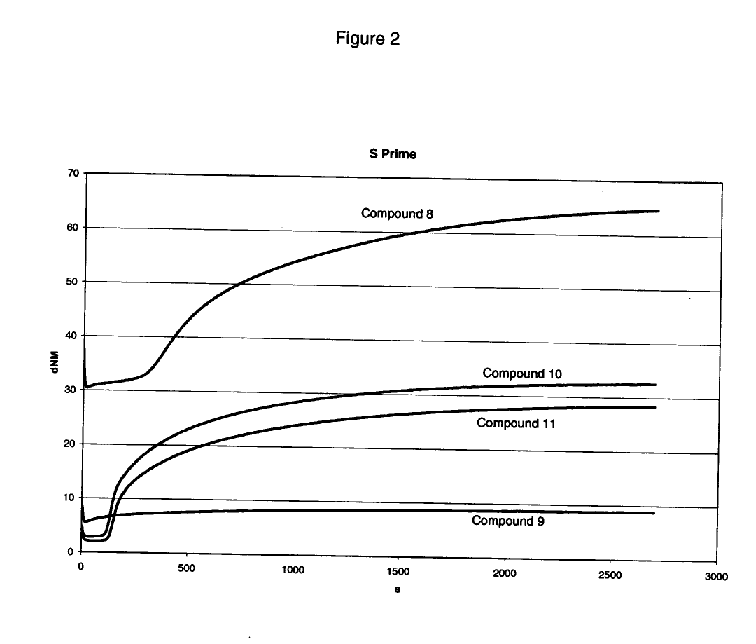

The test results are given in Table 2 and the MDR trace is shown in FIG. 2.

### Example 9 (Comparative)

The compound of Example 9 was based on a blend of commercial butyl rubber (70 parts of LANXESS Butyl RB 402) and commercial EPDM (30 parts of Buna EP T 3950) mixed on a mill. The remaining ingredients in the formulation were: 100 phr of proprietary white filler, 50 phr of carbon black (N 762) and 5.0 phr of Perkadox 1440B-PD.

The test results are given in Table 2 and the MDR trace is shown in FIG. 2.

### Example 10 (Inventive)

The compound of Example 10 was prepared similarly like Compound 9 except that 10 phr of Saret 517 was also present in the formulation.

The test results are given in Table 2 and the MDR trace is shown in FIG. 2.

### Example 11 (Inventive)

The compound of Example 11 was based on a blend of LANXESS experimental high isoprene butyl rubber (85 parts, isoprene content in the rubber=7.5 mol %) and commercial EPDM (15 parts of Buna EP T 3950) mixed on a mill. The remaining ingredients in the formulation were: 100 phr of proprietary white filler, 50 phr of carbon black (N 762), 10 phr of Saret 517 and 5.0 phr of Perkadox 14/40B-PD.

The test results are given in Table 2 and the MDR trace is shown in FIG. 2.

TABLE 2
Properties of the Compounds 7-11.

| | Compound number | | | | |
|---|---|---|---|---|---|
| | Comp. 7 | Comp. 8 | Comp. 9 | Comp. 10 | Comp. 11 |
| | XL10000; | XL10000 + | IIR + EPDM | IIR + | High IP IIR + |
| Property/ | no Saret | Saret | no Saret | EPDM + Saret | EPDM + Saret |
| value | (comparative) | (comparative) | (comparative) | (inventive) | (inventive) |
| Compound Mooney | 61.66 | CNT | 111.62 | 72.56 | 65.80 |
| (ML1 + 4@100° C.) | | | | | |
| Delta Torque (dN · m) | 2.85 | 34.36 | 3.32 | 29.76 | 26.34 |
| Delta t′50 − t′10 | 1.57 | 5.11 | 3.83 | 1.47 | 2.78 |
| (min) | | | | | |
| Hardness Shore A2 | 60 | 80 | 64 | 82 | 77 |
| (pts.) | | | | | |
| Ultimate Tensile | 2.54 | 6.72 | 2.30 | 5.66 | 7.19 |
| (MPa) | | | | | |
| Ultimate Elongation | 77 | 47 | 200 | 61 | 89 |
| (%) | | | | | |
| Change Hardness. | 1 | 0 | 7 | 1 | 0 |
| Shore A2 (pts.) | | | | | |
| Change Ultimate | 34 | 5 | 43 | 2 | −19 |
| Tensile (%) | | | | | |
| Change Ultimate | −18 | 4 | −50 | −5 | −15 |
| Elongation (%) | | | | | |
| Die C tear (kN/m) | 13.40 | 13.19 | 23.38 | 17.29 | 16.00 |
| DIN Abrasion Abrasion | 432 | 410 | 344 | 338 | 342 |
| Volume Loss (mm³) | | | | | |
| Compression Set, | 13.97 | 8.57 | 67.44 | 13.93 | 11.38 |
| Method B, % | | | | | |
| (22 hrs @ 100° C., | | | | | |
| deflection 25%) | | | | | |
| Air Permeability | CNT | CNT | 3.8 × 10⁻⁸ | 4.4 × 10⁻⁸ | 3.7 × 10⁻⁸ |
| (cm²/atm sec) | | | | | |
| Weight Change (%) | 1.0 | 0.7 | 2.2 | 1.3 | 1.5 |
| Volume Change (%) | 0.9 | 0.6 | 2.9 | 1.3 | 1.9 |

CNT = could not test

The results show that the inventive Compounds 10 and 11 are significantly improved over the comparative Compound 9 in terms of higher values of Shore A hardness, ultimate tensile, delta torque and better (i.e., lower) compression set. In addition, the values of Mooney viscosity indicate easier processability, the aged stress-strain properties are improved and the compounds cure faster. Finally, the inventive compounds display less volume and weight changes in ethylene glycol indicating a higher resistance to an electrolyte environment.

Overall, the MDR and stress-strain characteristics of the vulcanized compounds prepared according to the present invention are superior to those of a comparative compound based on a peroxide-curable butyl rubber LANXESS XL-10000. In particular, Shore A hardness and the ultimate tensile strength is improved, as well as delta torque is higher.

Also, the inventive compounds cured much faster and had higher values of hardness than the prior art compounds based on butyl-EPDM blends. This demonstrates a significant degree of crosslinking in the final products which are not intended for good processability in the molten state, as in JP 55-62943 Al. The rubber articles based on compounds according to the present invention are useful for sealing applications where a high Shore A hardness, good elongation, high tensile and low permeability to gases or moisture is important, such as for electrolytic condenser caps.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A rubber compound comprising a butyl rubber polymer, an olefin polymer of ethylene, at least one α-olefin and optionally, at least one diene, a non-polymeric multi-unsaturated peroxide curable cure modifier and a peroxide curing agent.

2. A rubber compound according to claim 1, wherein the olefin polymer is EP(D)M rubber.

3. A rubber compound according to claim 1, wherein the non-polymeric multi-unsaturated peroxide curable cure modifier is selected from a divinyl aromatic compound, a polyfuntional monomer comprising an electron attractive group or a mixture thereof.

4. A rubber compound according to claim 1, comprising 55 to 98 phr butyl rubber polymer, 2 to 45 phr of EP(D)M and 1 to 15 phr of a non-polymeric multi-unsaturated peroxide curable cure modifier.

5. A rubber compound according to claim 4, comprising 70 to 90 phr butyl rubber polymer, 10 to 30 phr of EP(D)M and 2 to 10 phr of a non-polymeric multi-unsaturated peroxide curable cure modifier.

6. A rubber compound according to claim 3, wherein the divinyl aromatic compound is selected from the group consisting of divinyl toluene, divinyl xylenes, divinyl naphthalene, divinyl pyridine, diisopropenylbenzene, divinyl benzene and mixtures thereof.

7. A rubber compound according to claim 3, wherein the polyfuntional monomer comprising an electron attractive group is selected from the group consisting of trimethylolpropane tri(meth)acrylate, polyethylene glycol di(meth)acrylate, ethylene di(methacrylate), ethylene glycol di(meth)acrylate, polyethylene glycol diacrylate, 1,6-hexanediol diacrylate, tetramethylolmethane tetracrylate, polypropylene glycol di(meth)acrylate or a mixture thereof.

8. A rubber compound according to claim 1, wherein the peroxide curing agent is selected from the group consisting of dialkylperoxides, ketalperoxides, aralkylperoxides, peroxide ethers, or peroxide esters.

9. A rubber compound according to claim 8, wherein the peroxide curing agent is selected from the group consisting of di-tert.-butylperoxide, bis-(tert.-butylperoxyisopropyl)-benzene, dicumylperoxide, 2,5-dimethyl-2,5-di(tert.-butylperoxy)-hexane, 2,5-dimethyl-2,5-di(tert.-butylperoxy)-hexene-(3), 1,1-bis-(tert.-butylperoxy)-3,3,5-trimethyl-cyclohexane, benzoylperoxide, tert.-butylcumylperoxide, tert.-butylperbenzoate and mixtures thereof.

10. A rubber compound according to claim 1, further comprising at least one filler.

11. A rubber compound according to claim 10, wherein the filler is carbon black.

12. A process for preparing a peroxide curable rubber compound comprising mixing a butyl rubber polymer, a polymer of ethylene, at least one α-olefin and optionally, at least one diene and non-polymeric multi-unsaturated peroxide curable cure modifier in the presence of a peroxide curing agent.

13. A shaped article comprising the compound according to claim 1.

14. A shaped article according to claim 13, wherein the shaped article is a container for pharmaceuticals, a condenser cap, a seal for fuel cells, a container containing electrolytes, rings, dampening devices, ordinary seals, and sealants.
